(19) United States
(12) Patent Application Publication
(10) Pub. No.: US 2024/0408693 A1
(43) Pub. Date: Dec. 12, 2024

(54) Hot Press Electrode and Method For Manufacturing the Same

(71) Applicants: TE Connectivity Solutions GmbH, Schaffhausen (CH); Tyco Electronics (Shanghai) Co., Ltd., Shanghai (CN)

(72) Inventors: Zongjie (Jason) Tao, Shanghai (CN); Dandan (Emily) Zhang, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 18/736,051

(22) Filed: Jun. 6, 2024

(30) Foreign Application Priority Data
Jun. 7, 2023 (CN) 202310671413.1

(51) Int. Cl. B23K 20/02; B23K 20/00; B23K 101/32

(52) U.S. Cl. CPC B23K 20/023; B23K 20/004; B23K 2101/32

(57) ABSTRACT

A hot press electrode includes a non-diamond substrate having a diamond edge part. The edge part is formed on an edge of the substrate and is adapted to press a wire and heat the wire to achieve a hot press welding of the wire.

### CROSS-REFERENCE TO RELATED APPLICATION

This application claims the benefit of Chinese Patent Application No. CN202310671413.1 filed on Jun. 7, 2023, in the State Intellectual Property Office of China, the whole disclosure of which is incorporated herein by reference.

### FIELD OF THE INVENTION

Embodiments of the present disclosure relate to a hot press electrode and a method for manufacturing the hot press electrode.

### BACKGROUND

In the prior art, due to the excessive cost of diamond and its difficulty in manufacturing and processing, non-diamond hot press electrodes are usually used for hot press welding of wires. However, non-diamond hot press electrodes have problems such as short lifespan, slow heating efficiency, and easy contamination by solder and flux.

### SUMMARY

According to an embodiment of the present disclosure, a hot press electrode includes a non-diamond substrate having a diamond edge part. The edge part is formed on an edge of the substrate and is adapted to press a wire and heat the wire to achieve a hot press welding of the wire.

### BRIEF DESCRIPTION OF THE DRAWINGS

The invention will now be described by way of example with reference to the accompanying Figures, of which:

FIG. 1 shows an illustrative view of a non-diamond substrate for a hot press electrode according to an exemplary embodiment of the present invention;

FIG. 2 shows an illustrative view of a diamond edge part formed on the edge of the non-diamond substrate shown in FIG. 1;

FIG. 3 shows an illustrative view of processing the diamond edge part shown in FIG. 2 into a serrated shape; and

FIG. 4 shows an illustrative view of using the hot press electrode to simultaneously position, press and heat multiple wires.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth to provide a thorough understanding of the disclosed embodiments. It will be apparent, however, that one or more embodiments may be practiced without these specific details. In other instances, well-known structures and devices are schematically shown to simplify the drawing.

A hot press electrode according to an embodiment of the present disclosure includes a non-diamond substrate, and a diamond edge part which is formed on an edge of the non-diamond substrate. The diamond edge part is adapted to press a wire and heat the wire to achieve a hot press welding of the wire.

According to another embodiment of the present disclosure, a method for manufacturing a hot press electrode comprises the steps of manufacturing a non-diamond substrate and forming a diamond edge part on an edge of the non-diamond substrate. The diamond edge part is adapted to press a wire and heat the wire to achieve a hot press welding of the wire.

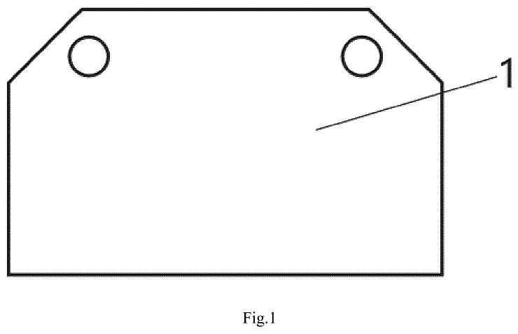

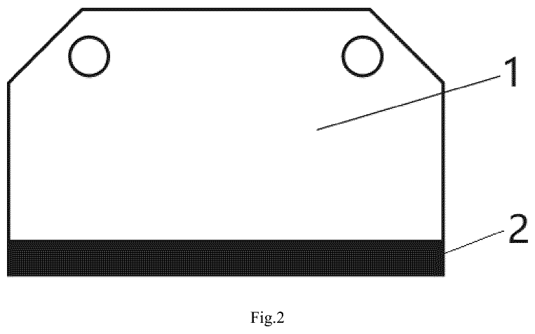

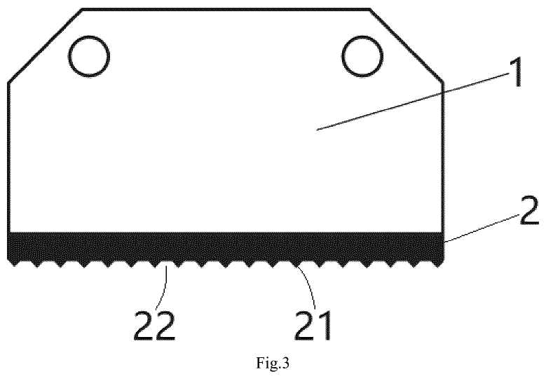

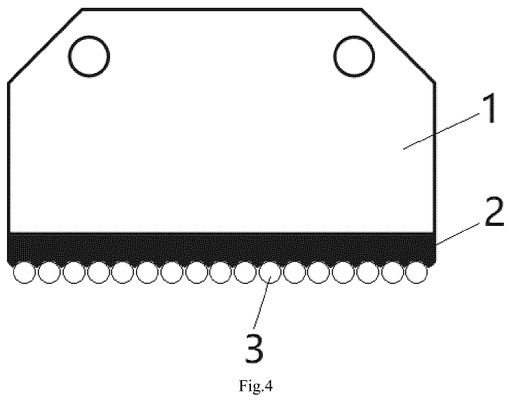

FIG. 1 shows an illustrative view of a non-diamond substrate 1 for a hot press electrode according to an exemplary embodiment of the present invention. FIG. 2 shows an illustrative view of forming the diamond edge part 2 on the edge of the non-diamond substrate 1 shown in FIG. 1. FIG. 3 shows an illustrative view of processing the diamond edge part 2 shown in FIG. 2 into a serrated shape. FIG. 4 shows an illustrative view of using the hot press electrode to simultaneously position, press and heat multiple wires 3.

As shown in FIGS. 1-4, in an exemplary embodiment of the present invention, a hot press electrode is disclosed. The hot press electrode mainly includes: a non-diamond substrate 1 and a diamond edge part 2. The diamond edge part 2 is used to directly press on a wire 3 to be welded, or a plurality of said wires, and heat the wire to achieve a hot press welding of the wire. As diamond is only formed on the edge of the non-diamond substrate 1 for pressing and heating the welded wire, the cost of the hot press electrode can be reduced, and the service life, heating efficiency, and stain resistance of the hot press electrode is also improved. Compared with traditional non-diamond hot press electrodes, the service life of the hot press electrode with diamond edge part 2 of the present disclosure is improved by about 500-2400%, and the heating efficiency is improved by about 20%. Further, the thermal conductivity of non-diamond substrate 1 is the same or close to that of diamond. This can prevent gaps between the non-diamond substrate 1 and the diamond edge part 2 caused by thermal expansion and contraction.

In an exemplary embodiment of the present disclosure, the non-diamond substrate 1 may be made of, for example, molybdenum alloy, but the present invention is not limited to this, and the non-diamond substrate 1 may also be made of other suitable materials. The diamond edge part 2 is formed on the non-diamond substrate 1 using Chemical Vapor Deposition (CVD). However, the present invention is not limited to this, and other suitable methods can also be used to form the diamond edge part 2 on the non-diamond substrate 1.

Still referring to FIGS. 1-4, the diamond edge part 2 is formed to be suitable for simultaneously positioning, pressing, and heating multiple wires 3. This can improve the welding efficiency of wires 3. The diamond edge part 2 is formed into a serrated shape, with a row of raised teeth 21 and a row of concave tooth slots 22. The row of tooth slots 22 is suitable for positioning a row of wires 3. This allows the diamond edge part 2 to simultaneously position, press, and heat multiple wires 3. The cross-section of the tooth slot 22 and/or the teeth 21 are V-shaped to be suitable for positioning wires 3 of different diameters, so that the same hot press electrode can weld wires 3 of different diameters.

In another exemplary embodiment of the present disclosure, a method for manufacturing a hot press electrode is also disclosed. The method of manufacturing the hot press electrode will be explained in detail below based on the attached diagrams. The method for manufacturing the hot press electrode includes the following steps of:
S10: As shown in FIG. 1, manufacturing the non-diamond substrate 1; and
S20: As shown in FIG. 2, forming the diamond edge part 2 on the edge of the non-diamond substrate 1.

In the illustrated embodiments, the diamond edge part 2 is used to press on the welded wire 3 and heat the wire 3 to achieve the hot press welding of wire 3. In an exemplary embodiment of the present invention, in step S20, the diamond edge part 2 is formed on a non-diamond substrate 1 using chemical vapor deposition method.

As shown in FIGS. 1 to 4, in an exemplary embodiment of the present invention, the step S10 comprises:
S11: providing the non-diamond substrate 1; and
S12: processing the non-diamond substrate 1 into a predetermined shape and size.

The thermal conductivity of non-diamond substrate 1 is the same or similar to that of diamond. For example, the non-diamond substrate 1 can be made of molybdenum alloy.

The method for manufacturing the aforementioned hot press electrode further comprises a step of:
S30: processing the diamond edge part 2 into a serrated shape.

As shown in FIGS. 1-4, the serrated diamond edge part 2 has a row of raised teeth 21 and a row of concave tooth slots 22. The row of tooth slots 22 is suitable for positioning a row of welded wires 3. This allows the diamond edge part 2 to simultaneously position, press, and heat multiple wires 3. In the illustrated embodiment, the cross-section of the tooth slot 22 and/or the teeth 21 are V-shaped to be able to position wires 3 with different diameters. In the step S30, wire cutting can be performed on the diamond edge part 2 to cut it into the serrated shape. For example, the diamond edge part 2 can be cut into the serrated shape by electric discharge wire cutting.

The method for manufacturing the aforementioned hot press electrode further comprises a step of:
S40: Polishing the diamond edge part 2 after wire cutting.

In this way, the burrs on the diamond edge part 2 can be removed, making the surface of the diamond edge part 2 smoother.

In addition, those areas in which it is believed that those of ordinary skill in the art are familiar, have not been described herein in order not to unnecessarily obscure the invention described. Accordingly, it must be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A hot press electrode, comprising:
a non-diamond substrate; and
a diamond edge part formed on an edge of the non-diamond substrate and adapted to press a wire and heat the wire to achieve the hot press welding of the wire.

2. The hot press electrode according to claim 1, wherein the thermal conductivity of the non-diamond substrate is approximately that of diamond.

3. The hot press electrode according to claim 2, wherein the non-diamond substrate is made of molybdenum alloy.

4. The hot press electrode according to claim 1, wherein the diamond edge part is formed on the non-diamond substrate using chemical vapor deposition.

5. The hot press electrode according to claim 1, wherein the diamond edge part is adapted to simultaneously positioning multiple wires, and to simultaneously press and heat multiple wires.

6. The hot press electrode according to claim 5, wherein the diamond edge part is formed into a serrated shape.

7. The hot press electrode according to claim 6, wherein the diamond edge part includes a row of raised teeth and a row of concave tooth slots.

8. The hot press electrode according to claim 7, wherein each of the tooth slots is adapted to position the wire, so that the diamond edge part can simultaneously position, press, and heat multiple wires.

9. The hot press electrode according to claim 8, wherein a cross-section of the tooth slot is generally V-shaped to be able to position wires with different diameters.

10. A method for manufacturing a hot press electrode comprising steps of:
manufacturing a non-diamond substrate; and
forming a diamond edge part on an edge of the non-diamond substrate,
wherein the diamond edge part is used to press a wire and heat the wire to achieve the hot press welding of the wire.

11. The method according to claim 10, wherein in the diamond edge part is formed on the non-diamond substrate using chemical vapor deposition method.

12. The method according to claim 10, wherein the step of manufacturing the non-diamond substrate includes:
providing the non-diamond substrate; and
processing the provided non-diamond substrate into a predetermined shape and size.

13. The method according to claim 10, wherein a thermal conductivity of the non-diamond substrate is the same or similar to that of diamond.

14. The method according to claim 13, wherein the non-diamond substrate is made of molybdenum alloy.

15. The method according to claim 10, further comprising a step of processing the diamond edge part into a serrated shape.

16. The method according to claim 15, wherein the serrated diamond edge part has a row of raised teeth and a row of concave tooth slots.

17. The method according to claim 16, wherein the row of concave tooth slots is adapted to position a row of wires, such that the diamond edge part is adapted to simultaneously position, press, and heat the row of wires.

18. The hot press electrode according to claim 17, wherein the cross-section of the tooth slot is V-shaped to be able to position wires with different diameters.

19. The method according to claim 15, wherein the step of processing the diamond edge part into a serrated shape includes performing wire cutting on the diamond edge part to cut the diamond edge part into the serrated shape.

20. The method according to claim 19, further comprising a step of polishing the diamond edge part after wire cutting.
